(19) United States
(12) Patent Application Publication
(10) Pub. No.: US 2023/0121479 A1
(43) Pub. Date: Apr. 20, 2023

(54) SYSTEM AND METHOD FOR ESTIMATING PROPERTIES ASSOCIATED WITH ROUTERS

(71) Applicant: COGNYTE TECHNOLOGIES ISRAEL LTD., Herzliya (IL)

(72) Inventors: Zeev Kalyuzhner, Herzliya Pitauch (IL); Yitshak Yishay, Herzliya Pitauch (IL); Itsik Horovitz, Herzliya Pitauch (IL); Offri Gil, Herzliya Pitauch (IL); Eithan Goldfarb, Herzliya Pitauch (IL)

(21) Appl. No.: 17/886,165

(22) Filed: Aug. 11, 2022

(30) Foreign Application Priority Data
Oct. 18, 2021 (IL) 287365

(51) Int. Cl. H04W 40/06; H04W 40/22; H04W 40/28

(52) U.S. Cl. CPC H04W 40/06; H04W 40/22; H04W 40/28

(57) ABSTRACT

The present disclosure provides method and system for a processor configured to receive, via a communication interface, cellular communication exchanged over at least one cellular network and fixed-network communication exchanged with a router connected to a fixed network. The method and system further correlating between the cellular communication and the fixed-network communication, and computing respective likelihoods for multiple cellular devices having connected to the fixed network via the router. In response to computing the likelihoods, compute one or more estimated properties associated with the router, and output the estimated properties.

### CROSS-REFERENCE TO RELATED APPLICATIONS

The present application is related to another application entitled “System and method for tracking cellular devices” (attorney ref. no. 1011-2013), filed on even date herewith.

### FIELD OF THE DISCLOSURE

The present disclosure relates to the field of communication monitoring.

### BACKGROUND OF THE DISCLOSURE

U.S. Pat. 8,665,728, whose disclosure is incorporated herein by reference, describes methods and systems for identifying network users who communicate with the network (e.g., the Internet) via a given network connection. The disclosed techniques analyze traffic that flows in the network to determine, for example, whether the given network connection serves a single individual or multiple individuals, a single computer or multiple computers. A Profiling System (PS) acquires copies of data traffic that flow through network connections that connect computers to the WAN. The PS analyzes the acquired data, attempting to identify individuals who login to servers.

U.S. Pat. 10,432,521, whose disclosure is incorporated herein by reference, describes an apparatus for monitoring a plurality of devices that use a plurality of networks. The apparatus includes a network interface and a processor. The processor is configured to receive, via the network interface, a plurality of packets that were collectively communicated, from the devices, via all of the networks, to aggregate the packets, using at least one field that is included in respective packet headers of the packets, into a plurality of packet aggregations, such that all of the packets in each one of the packet aggregations were collectively communicated from no more than one of the devices, to group the packet aggregations into a plurality of groups, such that there is a one-to-one correspondence between the groups and the devices, in that all of the packets in each of the groups were collectively communicated from a different respective one of the devices, and to generate an output in response thereto.

Sy, Erik, et al., “Tracking users across the web via TLS session resumption,” Proceedings of the 34th Annual Computer Security Applications Conference, 2018 investigates the applicability of TLS session resumption to user tracking.

### SUMMARY OF THE DISCLOSURE

There is provided, in accordance with some embodiments of the present disclosure, a system including a communication interface and a processor. The processor is configured to receive, via the communication interface, cellular communication packets exchanged over a cellular network and fixed-network communication packets exchanged with a router connected to a fixed network. The processor is further configured to identify, in the cellular communication packets, at least one data item exchanged with a cellular device at a cellular-communication time. The processor is further configured to identify the data item in the fixed-network communication packets. The processor is further configured to calculate, in response to identifying the data item in both the cellular communication packets and the fixed-network communication packets and based on a difference between the cellular-communication time and a fixed-network-communication time at which the data item was exchanged with the router, a likelihood that the cellular device was connected to the fixed network via the router at the fixed-network-communication time. The processor is further configured to output the likelihood.

In some embodiments, the processor is further configured to:
identify, in the cellular communication packets, a device-identifier used by the cellular device to identify itself on the cellular network,
identify, in the fixed-network communication packets, a router-identifier of the router, and
output the device-identifier and the router-identifier in association with the likelihood.

In some embodiments, the device-identifier includes an international mobile subscriber identity (IMSI).

In some embodiments, the router-identifier includes an Internet Protocol (IP) address of the router.

In some embodiments, the processor is further configured to:
based on the cellular communication packets and the fixed-network communication packets, calculate an estimated period of time during which the cellular device was connected to the fixed network via the router, and
output the estimated period of time in association with the likelihood.

In some embodiments, the data item includes a session-resumption identifier.

In some embodiments, the data item includes a certificate of the cellular device.

In some embodiments, the data item includes a user agent string.

In some embodiments, the data item includes a name of an application used for exchanging the cellular communication packets and fixed-network communication packets.

In some embodiments, the data item includes an Internet Protocol (IP) address of a server with which the cellular communication packets and fixed-network communication packets were exchanged.

In some embodiments, the processor is further configured to identify, based on the cellular communication packets, a base transceiver station (BTS) location of a BTS used by the cellular device at the cellular-communication time, and the processor is configured to calculate the likelihood as a function of a distance between the BTS location and an estimated router location of the router.

In some embodiments, the processor is further configured to output an estimated router location of the router in association with the likelihood.

In some embodiments, the processor is further configured to:
identify a Remote Authentication Dial-In User Service (RADIUS) identifier of the router from the fixed-network communication packets, and
compute the estimated router location from the RADIUS identifier.

In some embodiments, the fixed-network-communication time is subsequent to the cellular-communication time.

In some embodiments, the processor is further configured to identify, in the cellular communication packets, a disconnection indication that the cellular device disconnected from the cellular network with respect to data communication subsequently to the cellular-communication time and prior to the fixed-network communication time, and the processor is configured to calculate the likelihood in response to the disconnection indication.

In some embodiments, the processor is further configured to identify, in the fixed-network communication packets, a connection indication that an unknown device connected to the fixed network via the router subsequently to the cellular-communication time and prior to the fixed-network-communication time, and the processor is configured to calculate the likelihood in response to the connection indication.

In some embodiments, the fixed-network-communication time is prior to the cellular-communication time.

In some embodiments,
the data item is a first data item, the fixed-network communication packets are first fixed-network communication packets, the router is a first router, the fixed-network-communication time is a first fixed-network-communication time, and the likelihood is a first likelihood, and
the processor is further configured to:
   identify at least one second data item in the first fixed-network communication packets,
   identify the second data item in second fixed-network communication packets exchanged with a second router,
   in response to identifying the second data item in both the first fixed-network communication packets and the second fixed-network communication packets, calculate a second likelihood that the cellular device was connected to the fixed network, or to another fixed network, via the second router at a second fixed-network-communication time at which the second data item was exchanged with the second router, and
   output the second likelihood.

There is further provided, in accordance with some embodiments of the present disclosure, a method including identifying, in cellular communication packets exchanged over a cellular network, at least one data item exchanged with a cellular device at a cellular-communication time. The method further includes identifying the data item in fixed-network communication packets exchanged with a router connected to a fixed network. The method further includes, in response to identifying the data item in both the cellular communication packets and the fixed-network communication packets and based on a difference between the cellular-communication time and a fixed-network-communication time at which the data item was exchanged with the router, calculating a likelihood that the cellular device was connected to the fixed network via the router at the fixed-network-communication time. The method further includes outputting the likelihood.

There is further provided, in accordance with some embodiments of the present disclosure, a computer software product including a tangible non-transitory computer-readable medium in which program instructions are stored. The instructions, when read by a processor, cause the processor to identify, in cellular communication packets exchanged over a cellular network, at least one data item exchanged with a cellular device at a cellular-communication time. The instructions further cause the processor to identify the data item in fixed-network communication packets exchanged with a router connected to a fixed network. The instructions further cause the processor to calculate, in response to identifying the data item in both the cellular communication packets and the fixed-network communication packets and based on a difference between the cellular-communication time and a fixed-network-communication time at which the data item was exchanged with the router, a likelihood that the cellular device was connected to the fixed network via the router at the fixed-network-communication time. The instructions further cause the processor to output the likelihood.

There is further provided, in accordance with some embodiments of the present disclosure, a system, including a communication interface and a processor. The processor is configured to receive, via the communication interface, cellular communication packets exchanged with a cellular device over a cellular network and fixed-network communication packets exchanged with a router connected to a fixed network. The processor is further configured to identify, in the cellular communication packets, a disconnection indication that the cellular device disconnected from the cellular network with respect to data communication at a first time. The processor is further configured to identify, from the fixed-network communication packets, a connection indication that an unidentified device connected to the fixed network via the router at a second time. The processor is further configured to calculate, based on a time-difference between the second time and the first time, a likelihood that the cellular device connected to the fixed network via the router at the second time. The processor is further configured to output the likelihood.

In some embodiments, the processor is further configured to:
identify, from the cellular communication packets, a base transceiver station (BTS) location of a BTS used by the cellular device at the first time, and
calculate an estimated router location of the router, and
the processor is configured to calculate the likelihood based on a distance between the BTS location and the estimated router location.

In some embodiments, the processor is configured to calculate the likelihood as an increasing function of a number of previous instances in which other likelihoods were calculated for the cellular device having connected to the fixed network via the router.

There is further provided, in accordance with some embodiments of the present disclosure, a method including identifying, in cellular communication packets exchanged with a cellular device over a cellular network, a disconnection indication that the cellular device disconnected from the cellular network with respect to data communication at a first time. The method further includes identifying, from fixed-network communication packets exchanged with a router connected to a fixed network, a connection indication that an unidentified device connected to the fixed network via the router at a second time. The method further includes, based on a time-difference between the second time and the first time, calculating a likelihood that the cellular device connected to the fixed network via the router at the second time. The method further includes outputting the likelihood.

There is further provided, in accordance with some embodiments of the present disclosure, a computer software product including a tangible non-transitory computer-readable medium in which program instructions are stored. The instructions, when read by a processor, cause the processor to identify, in cellular communication packets exchanged with a cellular device over a cellular network, a disconnection indication that the cellular device disconnected from the cellular network with respect to data communication at a first time. The instructions further cause the processor to identify, from fixed-network communication packets exchanged with a router connected to a fixed network, a connection indication that an unidentified device connected to the fixed network via the router at a second time. The instructions further cause the processor to calculate, based on a time-difference between the second time and the first time, a likelihood that the cellular device connected to the fixed network via the router at the second time. The instructions further cause the processor to output the likelihood.

There is further provided, in accordance with some embodiments of the present disclosure, a system including a communication interface and a processor. The processor is configured to receive, via the communication interface, cellular communication exchanged over at least one cellular network and fixed-network communication exchanged with a router connected to a fixed network. The processor is further configured to compute, by correlating between the cellular communication and the fixed-network communication, respective likelihoods for multiple cellular devices having connected to the fixed network via the router. The processor is further configured to compute, in response to computing the likelihoods, one or more estimated properties associated with the router. The processor is further configured to output the estimated properties.

In some embodiments, the estimated properties include an estimated location of the router.

In some embodiments,
the processor is configured to compute the likelihoods based on respective instances in which the cellular devices used respective base transceiver stations (BTSs) before or after packets of the fixed-network communication were exchanged, and
the processor is configured to compute the estimated location based on an intersection of respective coverage areas of the BTSs.

In some embodiments, the processor is configured to compute the estimated properties based on respective magnitudes of the likelihoods.

In some embodiments, the estimated properties include an estimated type of facility serviced by the router.

In some embodiments, the processor is configured to compute the estimated type of facility by:
computing, for multiple different times, respective estimated numbers of the cellular devices that were concurrently connected to the fixed network via the router, and
computing the estimated type of facility based on the estimated numbers.

In some embodiments, the processor is configured to compute the estimated type of facility by:
computing respective estimated numbers of times at which one or more of the cellular devices connected to the fixed network via the router, and
computing the estimated type of facility based on the estimated numbers of times.

In some embodiments, the processor is further configured to calculate, by correlating between the cellular communication and the fixed-network communication, respective estimated periods of time during which the cellular devices were connected to the fixed network via the router, and the processor is configured to compute the estimated type of facility based on the estimated periods of time.

In some embodiments, the processor is configured to compute the estimated type of facility based on respective positions of the estimated periods of time within a larger recurring period of time.

In some embodiments, the processor is configured to compute the estimated type of facility based on a statistic of respective durations of the periods of time.

There is further provided, in accordance with some embodiments of the present disclosure, a method including, by correlating between cellular communication exchanged over at least one cellular network and fixed-network communication exchanged with a router connected to a fixed network, computing respective likelihoods for multiple cellular devices having connected to the fixed network via the router. The method further includes, in response to computing the likelihoods, computing one or more estimated properties associated with the router. The method further includes outputting the estimated properties.

There is further provided, in accordance with some embodiments of the present disclosure, a computer software product including a tangible non-transitory computer-readable medium in which program instructions are stored. The instructions, when read by a processor, cause the processor to compute, by correlating between cellular communication exchanged over at least one cellular network and fixed-network communication exchanged with a router connected to a fixed network, respective likelihoods for multiple cellular devices having connected to the fixed network via the router. The instructions further cause the processor to compute, in response to computing the likelihoods, one or more estimated properties associated with the router. The instructions further cause the processor to output the estimated properties.

The present disclosure will be more fully understood from the following detailed description of embodiments thereof, taken together with the drawings, in which:

### BRIEF DESCRIPTION OF THE DRAWINGS

FIG. 1 is a schematic illustration of a system for tracking cellular devices, in accordance with some embodiments of the present disclosure;

FIG. 2 is a schematic illustration of a technique for tracking cellular devices, in accordance with some embodiments of the present disclosure;

FIG. 3 is a schematic illustration of an example implementation of a tracking technique, in accordance with some embodiments of the present disclosure;

FIG. 4 is a schematic illustration of a technique for computing a lookup table, in accordance with some embodiments of the present disclosure; and

FIG. 5 is a flow diagram for an example algorithm for calculating a likelihood that a cellular device was connected to a fixed network via a router, in accordance with some embodiments of the present disclosure.

### DETAILED DESCRIPTION OF EMBODIMENTS

### Overview

In some cases, law-enforcement agencies may wish to track a cellular device. However, although the cellular device may be identified from the communication it exchanges over a cellular network, it may not be identified from similar communication over a fixed network.

To address this challenge, embodiments of the present disclosure provide a processor configured to correlate between cellular communication exchanged over a cellular network and fixed-network communication exchanged with a router connected to a fixed network. Based on this correlation, the processor computes respective likelihoods for one or more cellular devices having been connected to the fixed network via the router.

In some embodiments, the processor correlates between the cellular communication and the fixed-network communication by identifying particular types of data items contained both in packets of the cellular communication and in packets of the fixed-network communication. Examples of such data items include session-resumption identifiers (e.g., Transport Layer Security (TLS) Session IDs), device certificates, and user agent strings. In response to identifying the same one or more data items in both groups of packets, the processor calculates a likelihood that the cellular device that exchanged the data items over the cellular network also exchanged the data items over the fixed network, and hence, that the cellular device was connected to the fixed network via the router while the data items were exchanged over the fixed network. Typically, the aforementioned likelihood is based on the difference, for each data item, between the time at which the data item was exchanged over the cellular network and the time at which the data item was exchanged over the fixed network.

Typically, the processor also identifies instances in which a cellular device, with at least a threshold likelihood, connected to or disconnected from one of the networks with respect to data communication. The processor further calculates the likelihoods responsively to such instances. For example, if the processor sees that a cellular device disconnected from a cellular network after exchanging a data item over the cellular network and before the data item was exchanged over the fixed network, the processor may calculate a higher likelihood of the cellular device having been connected to the fixed network via the router while the data item was exchanged, relative to if this likely disconnection had not been seen.

In other embodiments, the processor correlates between the cellular communication and the fixed-network communication based on the aforementioned connection and disconnection instances, even without identifying any exchanges of the same data items over both networks. For example, in response to seeing that a cellular device disconnected from the cellular network shortly before or after an unidentified device connected to a router, the processor may calculate a likelihood that the cellular device is the unidentified device. The likelihood is based on the difference between the time of the connection to the second network and the time of the disconnection from the first network.

In some cases, in addition to computing the likelihood that the cellular device was connected to the router, the processor further computes an estimated location of the router, e.g., from a Remote Authentication Dial-In User Service (RADIUS) identifier of the router identified in the fixed-network communication packets. In such cases, the processor may output the estimated location of the router in association with the likelihood. Alternatively or additionally, the processor may further identify, based on the cellular communication packets, the location of a base transceiver station (BTS) used by the cellular device before or after the device was connected to the router. The processor may then calculate the likelihood as a function of the distance between the location of the BTS and the estimated location of the router.

In some embodiments, the processor, based on multiple likelihoods computed for respective cellular devices, computes and then outputs one or more estimated properties associated with the router. The estimated properties may include, for example, an estimated location of the router or an estimated type of facility serviced by the router.

For example, the location of the router may be estimated from multiple instances in which cellular devices used respective BTSs shortly before or after using the router. For example, the estimated location may be computed based on the intersection of the respective coverage areas of the BTSs.

As another example, the type of facility may be estimated from the number of devices that were concurrently connected to the router, and/or from the extent to which the same devices repeatedly connected to the router. For example, a router that repeatedly services the same devices may be posited to service a workplace if the number of devices is large, and a private residence if the number of devices is small. On the other hand, a router that services with less repetition may be posited to serve a public facility such as a café or hotel.

In addition to law-enforcement agencies, embodiments of the present disclosure may be used by service providers for marketing, auditing, improving network performance, and/or any other purposes. For example, a service provider may offer additional services, such as cybersecurity services, to customers who regularly connect to public routers. Alternatively, for example, a service provider may identify a router that is being used for a public facility despite having been provided exclusively for private use.

### System Description

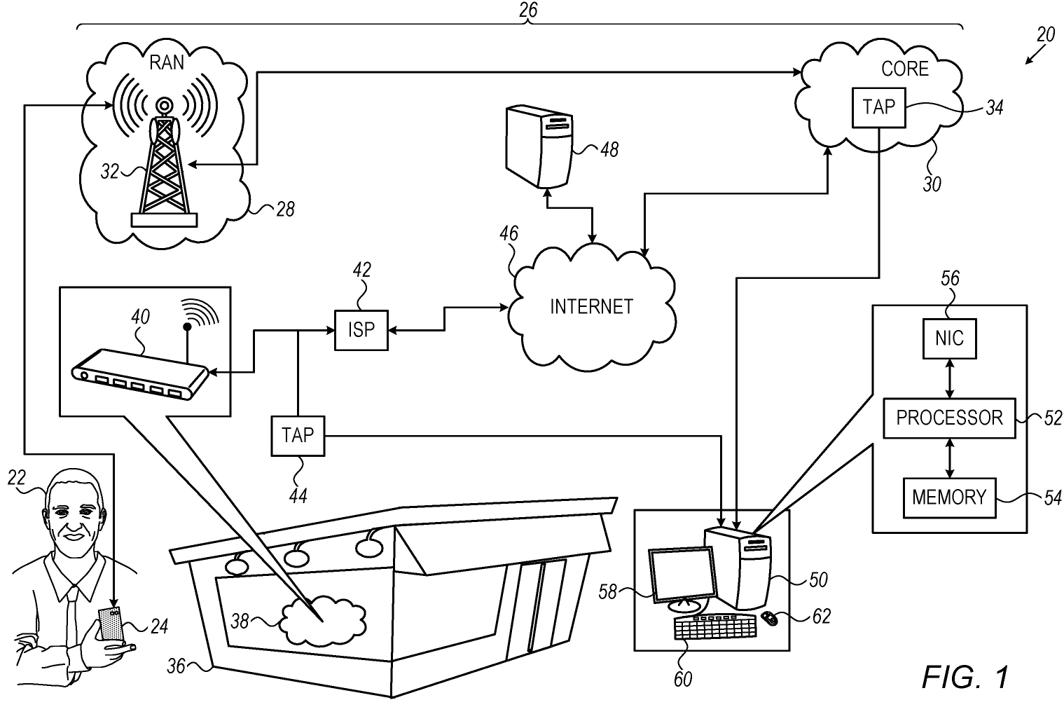

Reference is initially made to FIG. 1, which is a schematic illustration of a system 20 for tracking cellular devices, in accordance with some embodiments of the present disclosure.

FIG. 1 depicts a user 22 using a cellular device 24, which may include a smartphone, for example. Cellular device 24 exchanges cellular communication over a cellular network 26, which includes a radio access network (RAN) 28 and a core network 30. In particular, communication packets from device 24 are communicated wirelessly to a base transceiver station (BTS) 32 belonging to RAN 28. BTS 32 communicates these packets, typically over a wired connection, to core network 30. For those packets containing data communication (rather than voice communication), core network 30 communicates the packets over the Internet 46 to the intended recipients of the packets, such as a server 48 hosting a website or an application. The same communication pathway is used, in reverse, for communication packets sent to device 24.

FIG. 1 further depicts a router 40 servicing a facility 36 by providing a local area network (LAN) 38, such as a WiFi and/or Ethernet network, that is connected to a fixed network. Fixed-network communication is exchanged with router 40. In particular, router 40 receives fixed-network communication packets from devices in facility 36 and communicates these packets, via an Internet Service Provider (ISP) 42, to server 48 or any other device connected to Internet 46. Similarly, the router receives fixed-network communication packets from the Internet and communicates these packets to devices in facility 36.

System 20 comprises at least one first tap 34, configured to tap cellular communication exchanged over cellular network 26 with any number of devices 24. Typically, first tap 34 passively monitors the cellular communication, in that the first tap copies communication packets exchanged over the cellular network without intermediating the exchange of the packets.

Typically, first tap 34 is located within core network 30. For example, system 20 may comprise multiple first taps 34 located within the respective core networks of multiple cellular networks.

System 20 further comprises at least one second tap 44, configured to tap fixed-network communication exchanged via ISP 42 and any number of other ISPs. Typically, second tap 44 passively monitors the fixed-network communication.

System 20 further comprises a server 50, comprising a processor 52, a memory 54, and a communication interface 56 comprising, for example, a network interface controller (NIC). Memory 54 may comprise any suitable volatile memory, such as a random access memory (RAM), and/or non-volatile memory, such as a non-volatile memory belonging to a flash drive or hard drive.

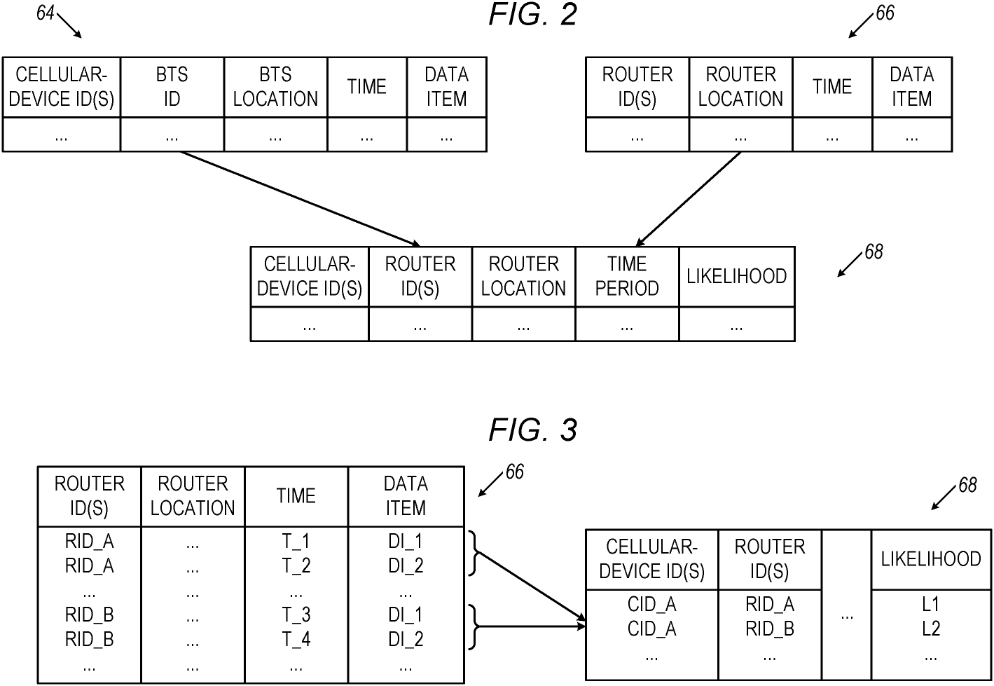

Processor 52 receives the copied communication packets from first tap 34 and second tap 44 via communication interface 56. (For simplicity, in the context of the present application, including the claims, a copy of a communication packet may be referred to simply as a “communication packet.”) The processor further processes the packets, e.g., as described below with reference to FIG. 2. The processor may further store any of the packets, and/or information derived from processing the packets, in memory 54.

Typically, system 20 further comprises a display 58. Processor 52 is configured to display any relevant outputs, such as the likelihoods described below with reference to FIGS. 2-3, on display 58. System 20 may further comprise one or more input devices, such as a keyboard 60 and/or a mouse 62, for inputting relevant inputs.

In general, processor 52 may be embodied as a single processor, or as a cooperatively networked or clustered set of processors. Such a set of processors may belong, for example, to multiple servers 50 in a cloud computing center.

The functionality of processor 52 may be implemented solely in hardware, e.g., using one or more fixed-function or general-purpose integrated circuits, Application-Specific Integrated Circuits (ASICs), and/or Field-Programmable Gate Arrays (FPGAs). Alternatively, this functionality may be implemented at least partly in software. For example, processor 52 may be embodied as a programmed processor comprising, for example, a central processing unit (CPU) and/or a Graphics Processing Unit (GPU). Program code, including software programs, and/or data may be loaded for execution and processing by the CPU and/or GPU. The program code and/or data may be downloaded to the processor in electronic form, over a network, for example. Alternatively or additionally, the program code and/or data may be provided and/or stored on non-transitory tangible media, such as magnetic, optical, or electronic memory. Such program code and/or data, when provided to the processor, produce a machine or special-purpose computer, configured to perform the tasks described herein.

### Tracking Cellular Devices

Reference is now made to FIG. 2, which is a schematic illustration of a technique for tracking cellular devices, in accordance with some embodiments of the present disclosure.

As cellular communication packets are received from first tap 34 (FIG. 1), processor 52 identifies, in the packets, data items that may be used for tracking the devices with which the packets were exchanged. One example of such a data item is a session-resumption identifier, such as a TLS Session ID or a Quick User Datagram Protocol Internet Connections (QUIC) Config ID, which typically appears in the handshake between a cellular device 24 and a server 48 (FIG. 1). Another example is a certificate of a cellular device. Yet another example is a user agent string, which may be included in a “client hello” message belonging to a TLS handshake. Other examples include a name of an application used for exchanging communication packets (e.g., an email or instant messaging application), an Internet Protocol (IP) address of a server 48 with which packets are exchanged, and any sequence of encrypted bits.

For each of the identified data items, processor 52 further identifies, in the cellular communications packets, at least one identifier of the cellular device with which the data item was exchanged, this identifier being used by the cellular device to identify itself on the cellular network. For example, the processor may identify the international mobile subscriber identity (IMSI) of the device, e.g., by deriving the IMSI from the IP address of the cellular device using General Packet Radio Service (GPRS) Tunnelling Protocol -C (GTP-C). The processor further identifies, in the cellular communications packets, the time at which the data item was exchanged.

In some cases, the processor further identifies, based on the cellular communication packets, the location of the BTS 32 (FIG. 1) used by the cellular device to exchange the data item. For example, the processor may first identify an identifier (e.g., a Cell ID) of the BTS specified in the cellular communication packets. Next, using the identifier, the processor may look up the location of the BTS in a table provided by the operator of cellular network 26 (FIG. 1).

Typically, each data item is stored by the processor in memory 54 (FIG. 1) in association with the time at which the data item was exchanged, at least one identifier of the device with which the data item was exchanged, an identifier of the BTS used to exchange the data item, and, if available, the location of the BTS. For example, each data item, with its associated information, may be stored as an entry in a first table 64.

Similarly, as fixed-network communication packets are received from second tap 44 (FIG. 1), processor 52 identifies the same types of data items in these packets. For each data item, the processor identifies, from the fixed-network communication packets, at least one identifier of the router 40 (FIG. 1) with which the data item was exchanged. For example, the processor may identify the IP address of the router, which is typically specified as the source or destination IP address in the packet containing the data item. Alternatively or additionally, the processor may identify a Remote Authentication Dial-In User Service (RADIUS) identifier of the router.

In some cases, the processor also estimates the location of the router. This location may be estimated with any suitable degree of precision. Thus, for example, the estimated location may include the physical address of the facility 36 (FIG. 1) serviced by the router, or simply the city in which the router is located.

For example, the processor may estimate the location of the router from the IP address of the router. For example, if the IP address is static, the processor may query ISP 42 (FIG. 1) for the location of the router to which the static IP address is assigned. Alternatively, even if the IP address is dynamic, the processor may look up the location using standard IP geolocation techniques. (Given that IP geolocation, along with some of the other techniques described immediately below, may be inaccurate in some cases, the present application generally refers to the computed router location as an “estimate.”)

As another example, the processor may estimate the location of the router from the RADIUS identifier of the router. In particular, the processor may derive the media access control (MAC) address of the router from the RADIUS identifier, and then query an appropriate database, such as a database provided by the ISP, for the location corresponding to the MAC address.

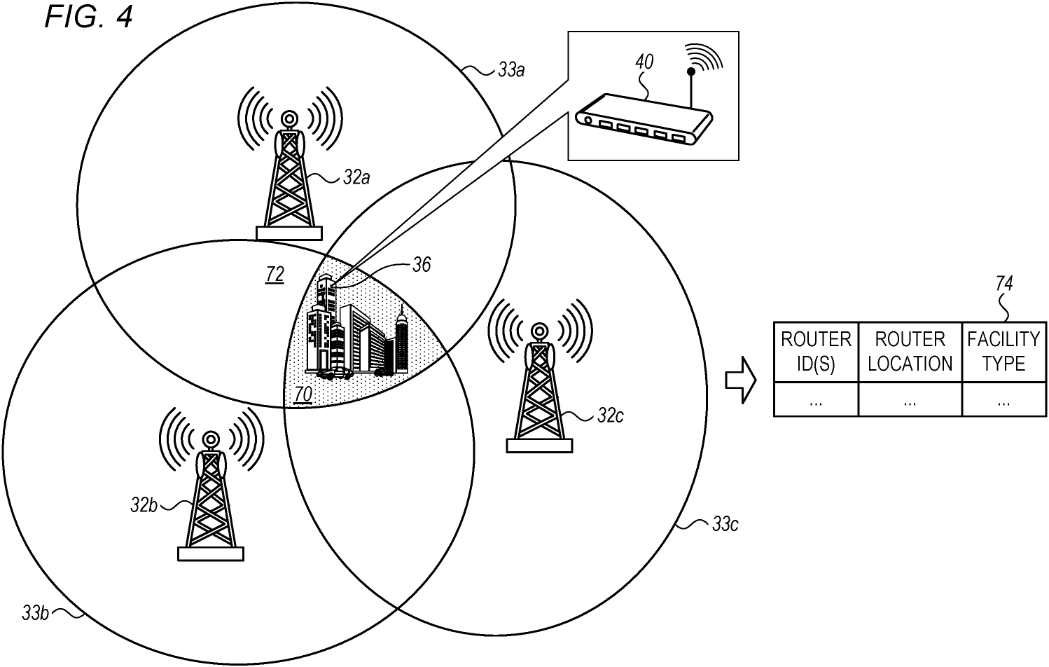

As yet another example, the processor may estimate the location of the router from leaked application data, such as unencrypted Global Positioning System (GPS) coordinates, or from a WiFi address book. Alternatively, the processor may look up an estimated location of the router in a lookup table stored by the processor, e.g., as further described below with reference to FIG. 4.

Typically, each data item identified in the fixed-network communication packets is stored by the processor in memory 54 (FIG. 1) in association with the time at which the data item was exchanged, at least one identifier of the router via which the data item was exchanged, and, if available, the estimated location of the router. For example, each data item, with its associated information, may be stored as an entry in a second table 66.

The processor further identifies instances in which the same one or more data items were both (i) exchanged with the same cellular device over the cellular network, and (ii) exchanged with the same router. In response to identifying such an instance of “shared data items,” the processor may calculate a likelihood that the cellular device was connected to a fixed network via the router while the data items were exchanged with the router.

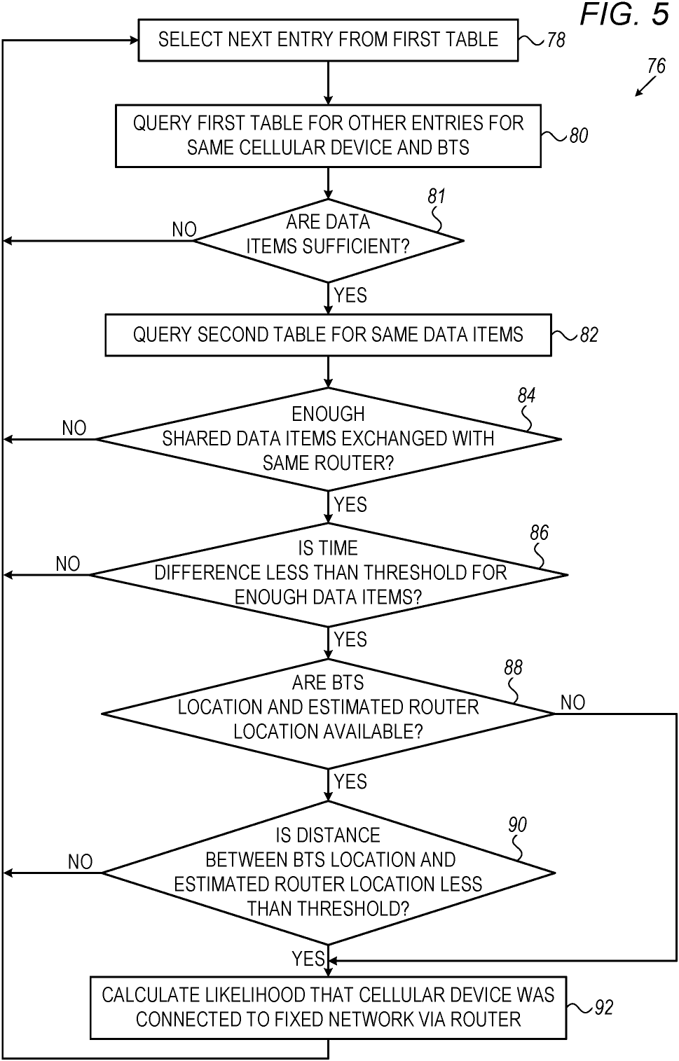

For example, as further described below with reference to FIG. 5, the processor may iterate through first table 64. For each group of one or more data items associated, in first table 64, with the same cellular-device identifier and the same BTS identifier, the processor may query second table 66 for the data items. In response to the query returning one or more of the data items in association with the same router identifier, the processor may calculate a likelihood that the cellular device to which the cellular-device identifier belongs was connected to the fixed network via the router to which the router identifier belongs.

Alternatively, the processor may iterate through second table 66. For each group of one or more data items associated, in second table 66, with the same router identifier, the processor may query first table 64 for the data items. In response to the query returning one or more of the data items in association with the same cellular-device identifier and the same BTS identifier, the processor may calculate the likelihood as described above.

As yet another alternative, instead of iterating through the first or second table, the processor may search for shared data items in response to relevant input from users of the system. For example, in response to the user inputting a particular device identifier, the processor may query first table 64 for any data items exchanged with the device, and then query second table 66 for the data items. Alternatively, in response to the user inputting a particular router identifier, the processor may query second table 66 for any data items exchanged with the router, and then query first table 64 for the data items.

Typically, the likelihood is based on the difference Δt, for each data item, between (i) the time at which the data item was exchanged in the cellular communication, and (ii) the time at which the data item was exchanged with the router. (The latter time may precede or follow the former time, i.e., Δt may be positive or negative.) In particular, the likelihood may be a decreasing function of the magnitude of this difference, with the rate of decrease (and the largest value for which a non-zero likelihood may be computed) varying across different types of data items.

In some cases, a shared data item may be “strong,” in that the shared data item may be sufficient cause, on its own, for a relatively high likelihood.

For example, session-resumption identifiers are relatively unique over short time spans, such as several hours or days. (In other words, it is relatively unlikely that multiple devices will use the same session-resumption identifier over a short time span.) Hence, the processor may calculate a relatively high likelihood for a shared session-resumption identifier even without any other shared data items, provided the time difference Δt for the shared session-resumption identifier is sufficiently small. As another example, the processor may calculate a relatively high likelihood for a shared Internet Protocol (IP) address of a server that participated in a relatively small number of other communication sessions with other nearby routers at the same time, provided Δt is sufficiently small.

In other cases, the processor may calculate a relatively high likelihood only in response to a strong combination of multiple shared data items. For example, if the same set of multiple server IP addresses appears in both the cellular communication and the fixed-network communication, the processor may calculate a relatively high likelihood that the same device communicated with the servers over both networks.

In some embodiments, the processor separates the packets exchanged via the router into multiple groups exchanged with different respective devices. This separation may be performed, for example, based on device identifiers, TCP timestamps, and/or any other data identified in the packets, e.g., as described in U.S. Pat. 10,432,521, whose disclosure is incorporated herein by reference.

In such embodiments, the processor may refrain from combining shared data items exchanged with different respective devices, by refraining from combining shared data items belonging to different respective groups. Moreover, even if a group includes a strong shared data item or combination of shared data items, the processor may calculate a likelihood of zero in response to a data item in the group that conflicts with another data item exchanged by the device over the cellular network. For example, if the group contains a user agent string that is different from the user agent string exchanged by the device over the cellular network, the processor may calculate a likelihood of zero that the device exchanged the group of packets.

For cases in which both the BTS location and estimated router location are available, the likelihood may also be a function of the distance between the BTS location and estimated router location. Thus, for example, even if a shared data item is “weak,” the processor may calculate a relatively high likelihood in response to a combination of the shared data item with a relatively small distance between the BTS location and the estimated router location.

In some embodiments, the processor further identifies, in the cellular communication packets, any indication that a cellular device connected to or disconnected from the cellular network with respect to data communication. A connection indication may include, for example, a connectivity check, a sign-in or connect message on the control plane, one or more messages on the control plane or data plane indicating the opening of one or more connections (e.g., a Transmission Control Protocol (TCP) SYN message), the opening of a bearer or packet data protocol (PDP) context, and/or an exchange of data communication with the device over the network following a predefined threshold amount of time during which no data was exchanged with the device over the network. Conversely, a disconnection indication may include, for example, a sign-out or disconnect message over the control plane, one or more messages on the control plane or data plane indicating the closing of one or more connections (e.g., a TCP FIN message), the closing of a bearer or PDP context, and/or a break in data communication with the device over the network, the duration of which exceeds a predefined threshold. Each such indication may be stored as an entry in first table 64 with a suitable word or code, such as “CONNECT” or “DISCONNECT,” assigned to the data-item field.

Alternatively or additionally, the processor may further identify, in the fixed-network communication packets, any indication that a device connected to or disconnected from a router. A connection indication may include, for example, a connectivity check, a new user agent string seen over multiple connections, the connection of background services, and/or an increase in the volume of communication exchanged with the router. Conversely, a disconnection indication may include the closing of multiple connections with the router at approximately the same time and/or a decrease in the volume of communication exchanged with the router. (The closing of a connection may be identified in response to a message, such as a TCP FIN message, indicating the closing, and/or in response to observing that no packets belonging to the connection were exchanged for a predefined threshold amount of time.) Each such indication may be stored as an entry in second table 66, as described above for first table 64.

In such embodiments, in response to identifying one or more shared data items exchanged over the cellular network and then with the router, the processor may check for a disconnection indication indicating that the cellular device disconnected from the cellular network subsequently to the exchange over the cellular network and prior to the exchange with the router. Alternatively or additionally, the processor may check for a connection indication indicating that a device connected to the router subsequently to the exchange over the cellular network and prior to the exchange with the router. The processor may then calculate the likelihood in response to the disconnection indication and/or the connection indication. For example, the processor may calculate a likelihood only if a disconnection indication or connection indication is found. Alternatively, in response to identifying the disconnection indication and/or connection indication, the processor may calculate an increased likelihood, relative to if the indication were not identified.

Similarly, for cases in which the shared data items are first exchanged with the router, the processor may check for a disconnection indication indicating that a device disconnected from the router subsequently to the exchange with the router and prior to the exchange over the cellular network. Alternatively or additionally, the processor may check for a connection indication indicating that the cellular device connected to the cellular network subsequently to the exchange with the router and prior to the exchange over the cellular network. The processor may then calculate the likelihood in response to the disconnection indication and/or the connection indication, as described above.

Typically, the likelihood is also a function of (i) the number of previous instances in which the processor posited that the device connected to the router, and (ii) the likelihoods with which the connection was posited in these instances.

In some embodiments, the processor computes the likelihood based on an increase in a TCP timestamp. For example, if the cellular-communication packet containing a shared data item includes a TCP timestamp t₁, and the subsequent fixed-network communication packet containing the data item includes a TCP timestamp t₂, the processor may calculate the likelihood as a decreasing function of the difference between t₂ - t₁ and a baseline. The baseline may be a function, for example, of the difference between the time at which the fixed-network communication packet was exchanged and the time at which the cellular-communication packet was exchanged.

Subsequently to calculating the likelihood, the processor may output the likelihood, e.g., on display 58 (FIG. 1) . Typically, the likelihood is output only if the likelihood exceeds a predefined threshold.

Typically, the likelihood is output in association with additional information, such as: (i) at least one identifier (e.g., the IP address and/or RADIUS identifier) of the router, (ii) the estimated location of the router (if available), and (iii) at least one identifier (e.g., the IMSI) of the cellular device. (As described below with reference to FIG. 4, the additional information may further include an estimated type of the facility serviced by the router.) For example, each likelihood, together with its associated information, may be entered into an output table 68, and output table 68 may then be displayed.

In some cases, the processor further calculates, based on the cellular communication packets and fixed-network communication packets, an estimated period of time during which the cellular device was connected to the router. Subsequently, the processor may output the estimated period of time in association with the likelihood, e.g., by including the estimated period of time in the appropriate entry in table 68.

For example, based on two sets of shared data items, the processor may posit that the cellular device disconnected from the cellular network and connected to the router, and then disconnected from the router and reconnected to the cellular network. The processor may therefore calculate the start of the period as the time of connection to the router, and the end of the period as the time of reconnection to the cellular network.

In some embodiments, the processor may calculate a likelihood that a cellular device connected to a fixed network via a router even without identifying any shared data items. For example, the processor may identify a disconnection indication indicating that a cellular device disconnected from the cellular network with respect to data communication at a first time. The processor may further identify a connection indication indicating that an unidentified device connected to the router at a second time prior to or subsequent to the first time. (As described above, the disconnection and connection indications may be saved in first table 64 and second table 66, respectively.) Subsequently, the processor may calculate a likelihood that the cellular device connected to the fixed network via the router at the second time (i.e., that the cellular device is the unidentified device), based on the difference between the second time and the first time. In particular, this likelihood may be a decreasing function of the absolute value of the difference, with differences greater than a threshold being mapped to a likelihood of zero.

In such embodiments, the likelihood may also be based on any of the additional factors described above, such as the distance between the BTS location and the estimated router location. Alternatively or additionally, the likelihood may be an increasing function of the number of previous instances in which other likelihoods were calculated for the cellular device having connected to the router. Thus, for example, if the cellular device was previously posited to have connected to the router, the likelihood may be higher, relative to if the cellular device was not previously posited to have connected to the router.

To conserve computing and memory resources, first table 64 and second table 66 may be regularly purged of any entries whose times precede the current time by more than a predefined threshold. (Optionally, different types of data items may have different thresholds.) Alternatively or additionally, subsequently to identifying each instance of shared data items, the processor may perform a sanity check prior to calculating a likelihood. For example, as further described below with reference to FIG. 5, the processor may refrain from calculating a likelihood if Δt exceeds a predefined threshold, or if the distance between the BTS location and the estimated router location exceeds a predefined threshold.

In some embodiments, the tracking techniques described above are executed by the processor in real-time. Thus, for example, the processor may posit that a device connected to a router while the device is still connected to the router. In other embodiments, the tracking techniques are executed retrospectively.

### Tracking Across Multiple Routers

Typically, the processor also identifies instances in which the same one or more data items are exchanged with two routers connected to the same fixed network or to different respective fixed networks. In response to identifying such an instance, the processor may calculate a likelihood that the same device was connected to the fixed network(s) via each of the routers at different times. The processor may then output the likelihood.

For example, the processor may iterate through second table 66. For each group of one or more data items associated, in second table 66, with the same router identifier, the processor may query second table 66 for other instances of the data items. In response to the query returning one or more of the data items in association with another router identifier, the processor may calculate a likelihood that the same device exchanged the shared data items with each of the two routers.

In this regard, reference is now made to FIG. 3, which is a schematic illustration of an example implementation of a tracking technique, in accordance with some embodiments of the present disclosure.

FIG. 3 assumes that, using the techniques described above with reference to FIG. 2, the processor has calculated a likelihood L1 that the cellular device having the identifier CID_A connected to a fixed network via a first router having the identifier RID_A. FIG. 3 further shows second table 66 containing: (i) a first data item DI_1, which was exchanged (a) with the first router at a time T_1, and (b) with a second router having the identifier RID_B at a subsequent time T_3, and (ii) a second data item DI_2, which was exchanged (a) with the first router at a time T_2, and (b) with the second router at a subsequent time T_4.

In this case, in response to ascertaining that the group of data items {DI_1, DI_2} was exchanged with both routers, the processor may calculate a likelihood L2 that the cellular device was also connected to the fixed network, or to another fixed network, via the second router. In this manner, the processor may further calculate a likelihood with respect to any number of additional routers.

In general, the likelihood depends on the factors described above with reference to FIG. 2, such as, for each shared data item, the type of shared data item and the difference between the times at which the shared data item was exchanged. For example, in the case shown in FIG. 3, L2 may be a function of T_3 - T_1 and T_4 -T_2.

It is noted that the processor may calculate and output a likelihood for the same device having connected to a fixed network, or to different respective fixed networks, via two routers, even without having identified the device from cellular communication (and hence, even without knowing an identifier of the cellular device).

### Estimating Properties Associated With a Router

Reference is now made to FIG. 4, which is a schematic illustration of a technique for computing a lookup table 74, in accordance with some embodiments of the present disclosure.

FIG. 4 depicts three BTSs belonging to a cellular network: a first BTS 32a having a first coverage area 33a, a second BTS 32b having a second coverage area 33b, and a third BTS 32c having a third coverage area 33c. FIG. 4 further depicts a facility 36 serviced by a router 40 connected to a fixed network. As users of cellular devices enter facility 36, the cellular devices disconnect from the cellular network and connect to the fixed network via router 40. Conversely, as the users exit facility 36, the cellular devices disconnect from the fixed network and connect to the cellular network.

In this scenario, processor 52 (FIG. 1) may compute respective likelihoods for the cellular devices having connected to the fixed network via the router, by correlating between cellular communication exchanged over the cellular network and fixed-network communication exchanged with the router. The correlating may be performed, for example, as described above with reference to FIG. 2. Subsequently, in response to computing the likelihoods, the processor may compute one or more estimated properties associated with the router, such as an estimated location of the router or the type of facility 36 serviced by the router.

For example, as described above with reference to FIG. 2, the processor may compute the likelihoods based on respective instances in which the cellular devices used respective BTSs shortly before or after packets of the fixed-network communication were exchanged. These instances may include, for example, an instance in which a cellular device exchanged one or more data items with a BTS shortly before or after the same data items were exchanged with router 40. (The definition of “shortly,” i.e., the largest interval for which a non-zero likelihood may be computed, may depend on the types of data items, as described above with reference to FIG. 2.) As another example, the instances may include an instance in which a cellular device disconnected from the BTS within a threshold interval before or after an unidentified device connected to the router, or an instance in which a cellular device connected to the BTS within a threshold interval before or after an unidentified device disconnected from the router.

Subsequently, the processor may compute the estimated location of the router based on the intersection 70 of respective coverage areas of the BTSs. (Intersection 70 is marked by a hatch pattern in FIG. 4.) For example, the value assigned to the estimated location may be the entire intersection 70 or a portion of the intersection.

Alternatively or additionally, the processor may compute, for multiple different times, respective estimated numbers of cellular devices that were concurrently connected to the fixed network via the router. For example, using the techniques described above with reference to FIGS. 2-3, the processor may ascertain, with respective likelihoods, that a first device was connected to the fixed network via the router at 9:00, a second device was connected to the fixed network via the router at 9:15, and a third device was connected to the fixed network via the router at 9:30. In response thereto, provided there is no indication of a device having disconnected from the fixed network prior to 9:30, the processor may compute an estimated number of three concurrent devices for 9:30.

Subsequently, the processor may compute the estimated type of facility based on the estimated numbers. For example, if the estimated number of concurrent devices exceeds a threshold number at more than a threshold number of times, the estimated type of facility may be a public facility or a workplace, rather than a private residence.

Alternatively or additionally to estimated numbers of concurrently-connected cellular devices, the estimated type of facility may be based on the estimated periods of time during which the cellular devices were connected to the fixed network via the router. For example, the estimated type of facility may be based on the respective positions of these estimated periods within a larger recurring period of time, such as a day or week. Thus, for example, if the cellular devices were connected to the fixed network mostly at night, the estimated type of facility may be a private residence or a night-entertainment facility. Alternatively or additionally, the estimated type of facility may be based on a statistic, such as an average, of the durations of the periods. For example, a longer average duration may indicate a private residence or workplace, while a shorter average duration may indicate a public facility.

Alternatively or additionally, the processor may compute respective estimated numbers of times at which one or more of the cellular devices connected to the fixed network via the router. In other words, the processor may compute the extent to which the same cellular devices repeatedly connected to the fixed network via the router. Subsequently, the processor may estimate the type of facility based on the estimated numbers of times. For example, if the estimated number of times is relatively low for most of the cellular devices (i.e., if relatively little repetition is seen), the estimated type of facility may be a public facility, rather than a workplace or a private residence.

Typically, the processor computes the estimated properties based on the magnitudes of the likelihoods for the cellular devices having connected to the fixed network via the router.

For example, the processor may compute (a) a first group of likelihoods by correlating between cellular communication exchanged with first BTS 32a and fixed-network communication exchanged with the router, (b) a second group of likelihoods by correlating between cellular communication exchanged with second BTS 32b and fixed-network communication exchanged with the router, and (c) a third group of likelihoods by correlating between cellular communication exchanged with third BTS 32c and fixed-network communication exchanged with the router. Subsequently, in response to the first and second groups of likelihoods being higher, on average, than the third group, the processor, in estimating the router location, may give greater weight to coverage areas 33a and 33b, relative to coverage area 33c. For example, the processor may include, in the estimated location, some or all of the area 72 in which the former coverages areas intersect one another without intersecting the latter coverage area.

Subsequently to computing the estimated properties, the processor outputs the estimated properties.

For example, the processor may store a router lookup table 74 in memory 54 (FIG. 1). In response to computing estimated properties associated with any router, the processor may add an entry for the router to lookup table 74, the entry including one or more identifiers of the router along with the estimated properties.

Subsequently, the processor may output the lookup table, e.g., on display 58 (FIG. 1). Alternatively or additionally, the processor may retrieve the estimated properties from the lookup table when performing the techniques described above with reference to FIG. 2, and then include the estimated properties in output table 68 (FIG. 2).

Thus, for example, the processor may first output a likelihood that a particular cellular device connected to a particular router, without outputting an estimated location or facility type. (For example, the processor may leave these fields blank in output table 68.) Subsequently, based on additional computed likelihoods for the same router, the processor may compute an estimated location and/or facility type. The processor may then output the likelihood for a second time, this time including the estimated location and/or facility type.

### Example Algorithm

Reference is now made to FIG. 5, which is a flow diagram for an example algorithm 76 for calculating a likelihood that a cellular device was connected to a fixed network via a router, in accordance with some embodiments of the present disclosure.

Per algorithm 76, processor 52 (FIG. 1) repeatedly iterates through first table 64 (FIG. 2), selecting the entries in the table, in sequence, at an entry-selecting step 78. Subsequently to selecting each entry, the processor, at a first querying step 80, queries the first table for other entries for the same cellular device and BTS as the selected entry. The processor thus retrieves one or more data items exchanged by the cellular device with the BTS.

Next, the processor checks, at a checking step 81, whether the data items are sufficient, i.e., whether the data items, if shared, are potentially cause for a likelihood exceeding a predefined threshold. For example, as described above with reference to FIG. 2, a session-resumption identifier may be sufficient on its own, while another type of data item, such as an IP address of a server, may be sufficient only in combination with one or more other data items.

If the data items are insufficient, the processor returns to entry-selecting step 78. Otherwise, the processor performs a second querying step 82, at which the processor queries second table 66 (FIG. 2) for the same data items retrieved from the first table.

Based on the result from second querying step 82, the processor checks, at another checking step 84, whether there are enough shared data items that were exchanged with the same router. If not, the processor returns to entry-selecting step 78. Otherwise, the processor performs another checking step 86, at which the processor checks, for each of the shared data items, whether Δt is less than a threshold. (As described above with reference to FIG. 2, the threshold may vary between the data items.) If Δt is less than the threshold for a sufficient number of data items, the processor proceeds to another checking step 88. Otherwise, the processor returns to entry-selecting step 78.

At checking step 88, the processor checks whether the location of the BTS and an estimated location of the router are available. If yes, the processor checks, at another checking step 90, whether the distance between the BTS location and the estimated router location is less than a threshold. If yes, or if the BTS location and estimated router location are not both available, the processor, at a calculating step 92, calculates a likelihood that the cellular device was connected to the fixed network via the router while the shared data items were exchanged with the router. Subsequently, or if the distance between the BTS location and the estimated router location is not less than the threshold, the processor returns to entry-selecting step 78.

It will be appreciated by persons skilled in the art that the present invention is not limited to what has been particularly shown and described hereinabove. Rather, the scope of embodiments of the present invention includes both combinations and subcombinations of the various features described hereinabove, as well as variations and modifications thereof that are not in the prior art, which would occur to persons skilled in the art upon reading the foregoing description. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A system, comprising:
a communication interface; and
a processor, configured to:
receive, via the communication interface, cellular communication exchanged over at least one cellular network and fixed-network communication exchanged with a router connected to a fixed network,
by correlating between the cellular communication and the fixed-network communication, compute respective likelihoods for multiple cellular devices having connected to the fixed network via the router,
in response to computing the likelihoods, compute one or more estimated properties associated with the router, and
output the estimated properties.

2. The system according to claim 1, wherein the estimated properties include an estimated location of the router.

3. The system according to claim 2,
wherein the processor is configured to compute the likelihoods based on respective instances in which the cellular devices used respective base transceiver stations (BTSs) before or after packets of the fixed-network communication were exchanged, and
wherein the processor is configured to compute the estimated location based on an intersection of respective coverage areas of the BTSs.

4. The system according to claim 1, wherein the processor is configured to compute the estimated properties based on respective magnitudes of the likelihoods.

5. The system according to claim 1, wherein the estimated properties include an estimated type of facility serviced by the router.

6. The system according to claim 5, wherein the processor is configured to compute the estimated type of facility by:
computing, for multiple different times, respective estimated numbers of the cellular devices that were concurrently connected to the fixed network via the router, and
computing the estimated type of facility based on the estimated numbers.

7. The system according to claim 5, wherein the processor is configured to compute the estimated type of facility by:
computing respective estimated numbers of times at which one or more of the cellular devices connected to the fixed network via the router, and
computing the estimated type of facility based on the estimated numbers of times.

8. The system according to claim 5, wherein the processor is further configured to calculate, by correlating between the cellular communication and the fixed-network communication, respective estimated periods of time during which the cellular devices were connected to the fixed network via the router, and wherein the processor is configured to compute the estimated type of facility based on the estimated periods of time.

9. The system according to claim 8, wherein the processor is configured to compute the estimated type of facility based on respective positions of the estimated periods of time within a larger recurring period of time.

10. The system according to claim 8, wherein the processor is configured to compute the estimated type of facility based on a statistic of respective durations of the periods of time.

11. A method, comprising:
by correlating between cellular communication exchanged over at least one cellular network and fixed-network communication exchanged with a router connected to a fixed network, computing respective likelihoods for multiple cellular devices having connected to the fixed network via the router;
in response to computing the likelihoods, computing one or more estimated properties associated with the router; and
outputting the estimated properties.

12. The method according to claim 11, wherein the estimated properties include an estimated location of the router.

13. The method according to claim 12,
wherein computing the likelihoods comprises computing the likelihoods based on respective instances in which the cellular devices used respective base transceiver stations (BTSs) before or after packets of the fixed-network communication were exchanged, and
wherein computing the estimated location comprises computing the estimated location based on an intersection of respective coverage areas of the BTSs.

14. The method according to claim 11, wherein computing the estimated properties comprises computing the estimated properties based on respective magnitudes of the likelihoods.

15. The method according to claim 11, wherein the estimated properties include an estimated type of facility serviced by the router.

16. The method according to claim 15, wherein computing the estimated type of facility comprises:
computing, for multiple different times, respective estimated numbers of the cellular devices that were concurrently connected to the fixed network via the router; and
computing the estimated type of facility based on the estimated numbers.

17. The method according to claim 15, wherein computing the estimated type of facility comprises:
computing respective estimated numbers of times at which one or more of the cellular devices connected to the fixed network via the router; and
computing the estimated type of facility based on the estimated numbers of times.

18. The method according to claim 15, further comprising, by correlating between the cellular communication and the fixed-network communication, calculating respective estimated periods of time during which the cellular devices were connected to the fixed network via the router, wherein computing the estimated type of facility comprises computing the estimated type of facility based on the estimated periods of time.

19. The method according to claim 18, wherein computing the estimated type of facility comprises computing the estimated type of facility based on respective positions of the estimated periods of time within a larger recurring period of time.

20. (canceled)

21. A computer software product comprising a tangible non-transitory computer-readable medium in which program instructions are stored, which instructions, when read by a processor, cause the processor to:
by correlating between cellular communication exchanged over at least one cellular network and fixed-network communication exchanged with a router connected to a fixed network, compute respective likelihoods for multiple cellular devices having connected to the fixed network via the router,
in response to computing the likelihoods, compute one or more estimated properties associated with the router, and
output the estimated properties.
